(19) United States
(12) Patent Application Publication
(10) Pub. No.: US 2008/0202309 A1
(43) Pub. Date: Aug. 28, 2008

(54) MUSICAL INSTRUMENT AND METHOD OF CONSTRUCTION THEREFOR

(76) Inventor: John R. Wiswell, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/677,914

(22) Filed: Feb. 22, 2007

(51) Int. Cl. G10D 3/00

(52) U.S. Cl. 84/291

(57) ABSTRACT

A stringed musical instrument such as an electric guitar includes a body made of metal and composite components. The use of such materials permits the design of an instrument having desired sound characteristics. The musical instruments fabricated according to the present invention are very consistent from one instrument to the next, and sound variations due to use of materials having variable material properties is eliminated.

### BACKGROUND OF THE INVENTION

Various types of stringed musical instruments have been developed. In general, such instruments include a plurality of strings having adjustable tension to tune the instruments. One common type of stringed musical instrument includes a body and an elongated neck that the strings extend along. The body of such instruments may have a variety of shapes. Examples include violins, violas, cellos, and basses. Also, various types of guitars have also been developed. In addition to acoustical guitars, electric guitars having electrical pick ups to amplify the sound generated by the strings have been developed.

Stringed musical instruments are commonly made from wood. However, due to the variability in the density and other properties of the wood, the sound of each individual instrument may vary, even if the individual instruments are fabricated in the same manner according to the same design specification. This variability may cause a significant percentage of the instruments made to have sound qualities that are at least somewhat less than optimum. In general, stringed instruments will tend to have one or more resonant frequencies that contribute substantially to the overall sound and tone qualities of the instrument. If, however, the resonant frequencies do not occur at optimal frequency ranges, the instrument will not provide the desired sound.

Particular problems can occur if one of the natural frequencies of the instrument is too close to a standard musical note. If a player plays a note that is the same as, or close to, a resonant frequency of the instrument, the instrument will “twang” and generate a relatively large, unpleasant sound at that particular note due to the excitation of the resonant frequency. If a particular instrument has a resonant frequency that is equal to, or directly adjacent to, the frequency of a standard musical note, the instrument will not play well because it will produce a substantially different sound when the note occurring at the resonant frequency is played. This problem is quite common in instruments made from wood or other conventional materials. This problem is believed to be exacerbated due to the variability of wood and/or other materials having variable properties.

Accordingly, a stringed instrument and method of making the same alleviating the above-identified drawbacks of known stringed musical instruments would be beneficial.

### SUMMARY OF THE INVENTION

One aspect of the present invention is a musical instrument such as an electric guitar or the like including a body having a plurality of first connectors adapted to hold guitar strings. The electric guitar includes an elongated neck extending from the body. The neck includes a plurality of second connectors adapted to hold guitar strings in tension. The electric guitar includes at least one pick up adapted to generate a signal that can be communicated to an amplifier. At least a portion of the body is made of a first material having consistent material properties. The first material may be a metal such as aluminum. A second portion of the body is made of a second material having different material properties than the first material. The second material may be a carbon fiber composite material or other suitable material having relatively consistent material properties. Although the body of the instrument may be solid, hollow, or partially hollow, in a preferred embodiment the first and second portions of the body define at least one internal cavity that affects a resonant frequency of the musical instrument. The body defines a plurality of resonant frequencies in the range of about 100 Hz to about 2000 Hz, and each of the resonant frequencies are at least one half step away from each of the frequencies of musical notes as defined by the American Standard Pitch scale.

Another aspect of the present invention is a method of making a stringed musical instrument having a body, a neck, and a plurality of strings. The method includes determining desired resonant tone characteristics for the musical instruments. The method further includes determining a shape of the body of the musical instrument that will provide at least some of the desired tone characteristics for the musical instrument. The body of the instrument is fabricated from materials having sufficiently consistent material properties so as to consistently provide the desired tone characteristics. At least a substantial portion of the body of the musical instrument is a made of a material other than wood.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a front elevational view of an electric guitar according to one aspect of the present invention;

FIG. 2 is a cross section of a portion of an electric guitar taken along the line II-II; FIG. 1;

FIG. 3 is a cross section of a portion of an electric guitar taken along the line III-III; FIG. 1;

FIG. 4 is a cross section of a portion of an electric guitar taken along the line IV-IV; FIG. 1;

FIG. 5 is a cross section of a portion of an electric guitar taken along the line VI-VI; FIG. 1;

FIG. 6 is a graph showing the resonant tone curves for the electric guitar of FIG. 1;

FIG. 7 is a resonant tone curve for a prior art Fender 1960 Stratocaster electric guitar;

FIG. 8 is a resonant tone curve for a prior art Gibson 1959 Les Paul Reissue electric guitar;

FIG. 9 is a front elevational view of a primary structural member of the body of the electric guitar of FIG. 1;

FIG. 10 is a front elevational view of a primary structural member of the body of the electric guitar of FIG. 1 with a 0.25 inch grid superimposed on the primary structure to show the dimensions thereof;

FIG. 11 is a front elevational view of an upper front plate member of the electric guitar of FIG. 1;

FIG. 12 is a front elevational view of a middle front plate member of the electric guitar of FIG. 1;

FIG. 13 is a front elevational view of a lower front plate member of the electric guitar of FIG. 1;

FIG. 14 is a front elevational view of a rear plate member for the electric guitar of FIG. 1; and

FIG. 15 is a cross-sectional view of the carbon fiber plates of FIGS. 11-14.

### DETAILED DESCRIPTION OF PREFERRED EMBODIMENT

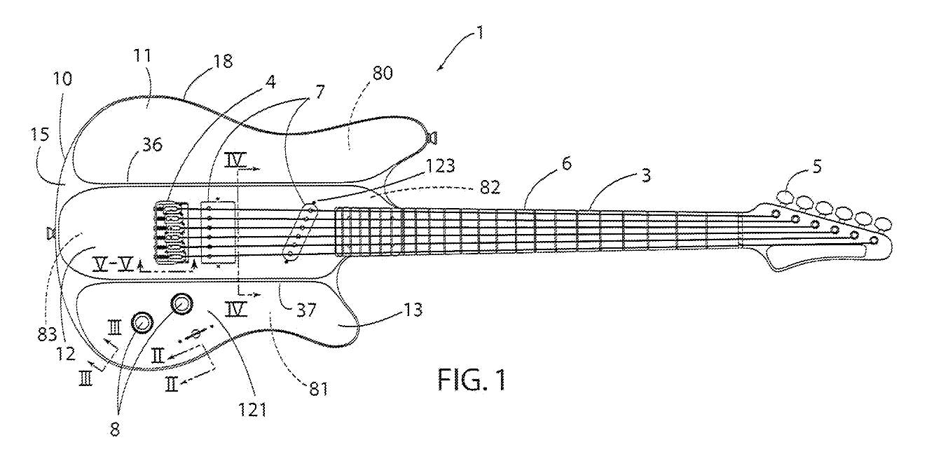

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

A stringed musical instrument such as an electric guitar 1 (FIG. 1) includes a body portion 2, and a neck 3 extending from the body portion 2. A plurality of first connectors 4 on the body 2, and second connectors 5 on the neck 3 connect a plurality of guitar strings 6 to the electric guitar 1. A plurality of electric pick ups 7 are configured to generate a signal that can be communicated to an electric amplifier in a known manner. Controls 8 provide for control of tone, volume, and the like in the known manner.

The body 2 of electric guitar 1 includes a primary structure 10 that is preferably made of an aluminum material. A plurality of plate-like members 11-13 are secured to a front side face 15 of primary structure 10, and a rear plate member 14 (see also FIG. 15) is secured to a rear face of the primary structure 10. The plate-like members 11-13 and 14 are made of a carbon fiber material. The neck 3 may be made from a variety of materials. In a preferred embodiment, the neck 3 is made according to the arrangement disclosed in U.S. Pat. No. 6,774,292 to Maca, the entire contents of which are hereby incorporated by reference.

As discussed in more detail below, the use of materials such as aluminum and carbon fiber composite permits the dimensions and other physical properties of the electric guitar 1 to be precisely controlled. In this way, the electric guitar 1 can be designed to provide a specific sound/tone. For example, the electric guitar 1 may be designed to match the sound qualities of classical guitars that are widely regarded as having superior sound qualities. Also, the use of materials having consistent material properties also permits the variations from instrument-to-instrument found in previous wood-bodied electric guitars to be eliminated. Still further, as also discussed in more detail below, the resonant frequencies of the electric guitar 1 can be controlled utilizing materials such as metal and carbon fiber to thereby design the electric guitar 1 in such a way that the resonant frequencies fall well between standard musical notes, to thereby eliminate the undesirable sound that would otherwise be created due to the existence of a resonant frequency at or near a standard musical note.

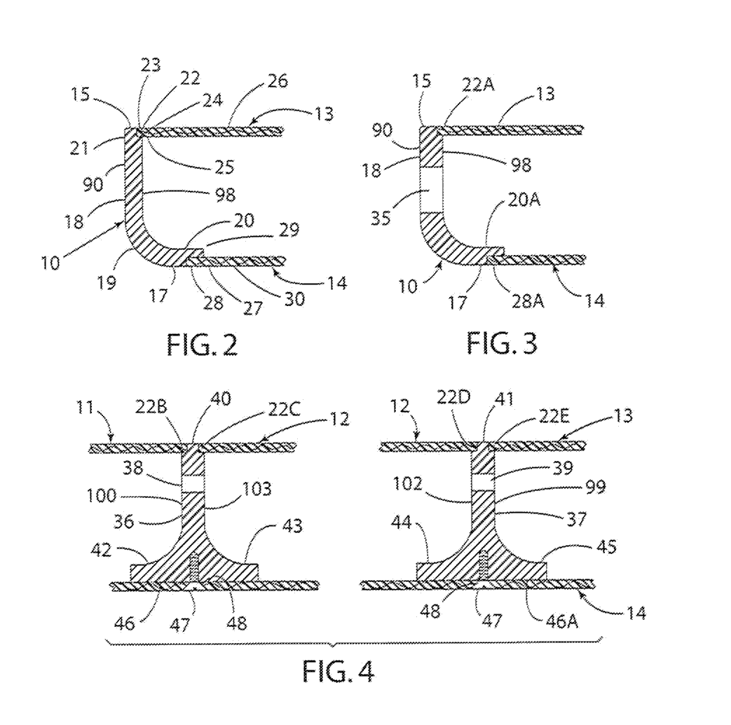

With further reference to FIG. 2, primary structure 10 includes a side wall 18 that extends generally transverse to the front face 15 and rear face 17 of the primary structure 10. Although the side wall 18 could have a variety of configurations, side wall 18 preferably has a substantially uniform cross-sectional thickness, with a gently radiused corner portion 19 that wraps around to form a rear lip 20. Upper edge portion 21 of side wall 18 includes a notch 22 formed by flat surfaces 23 and 24. Edge portion 25 of plate-like member 13 fits into notch 22 and positions the plate member 13 with outer surface 26 substantially flush with front side face 15 of primary structural member 10. Similarly, edge portion 27 of rear plate member 14 is received in notch 28 at end portion 29 of rear lip 20, with outer surface 30 of rear plate member 14 flush with rear face 17 of primary structure 10. In a preferred embodiment, the front plate-like members 11-13 are adhesively bonded to the primary structure 10 utilizing a suitable adhesive such as Loctite® Hisol adhesive disposed around the edge portions of the front plate-like members 11-13 at the notch 22. Also, as described in more detail below, rear plate member 14 is secured to the primary structural member 10 utilizing conventional threaded fasteners or the like that permit removal of rear plate member 14 to provide access to the interior of the guitar body 2.

As shown in FIG. 3, an aperture 35 through side wall 18 provides for routing of electrical lines or the like through side wall 18 if required to power and provide communications with the internal electronic components (not shown) of electric guitar 1. These internal components are generally known, and they will not therefore be described in detail. Notch 28 of primary structure 10 supports rear plate member 14 in the area of the line III-III of FIG. 1 in substantially the same manner as in the area of the section line II-II; FIG. 1. Notch 28 extends around substantially the entire perimeter of primary structural member 10 to support rear plate member 14 about its outer edge.

With further reference to FIG. 4, aluminum primary structure 10 includes a pair of parallel internal side walls 36 and 37. An aperture 38 through side wall 36, and an aperture 39 through side wall 37 provides for passing wires (not shown) through the side walls 36 and 37 if required for the various internal electrical components (not shown). A pair of notches 22B and 22C at end 40 of side wall 36 provide for support and mounting of plate members 11 and 12, and notches 22D and 22E at end 41 of side wall 31 provides for mounting and support of plates 12 and 13. It will be understood that adhesive such as Loctite® Hisol may be utilized around the entire edges of front plate-like members 11-13.

Internal side wall 36 includes a pair of extensions 42 and 43, and internal sidewall 37 includes a pair of extensions 44 and 45. The extensions 42-45 result in an upside-down T-shape cross section for the internal side walls 36 and 37 when viewed in the orientation of FIG. 4. Internal side wall 36 defines an end surface 46, and internal side wall 37 defines an end surface 46A. The rear plate member 14 abuts the surfaces 46 and 46A, and a plurality of threaded fasteners 47 extend through rear plate member 14 into tapped threaded openings 48 in internal side walls 36 and 37 to thereby removably secure the rear plate member 14 to the primary structure 10.

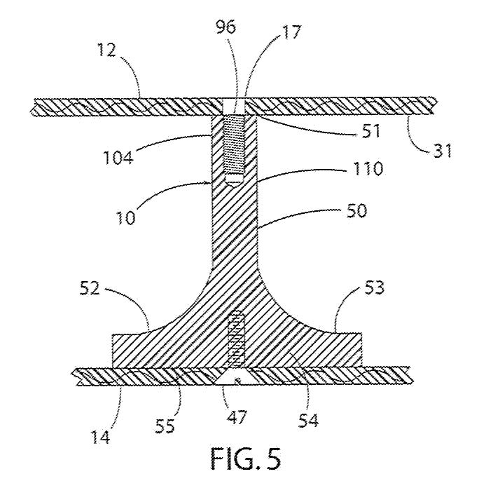

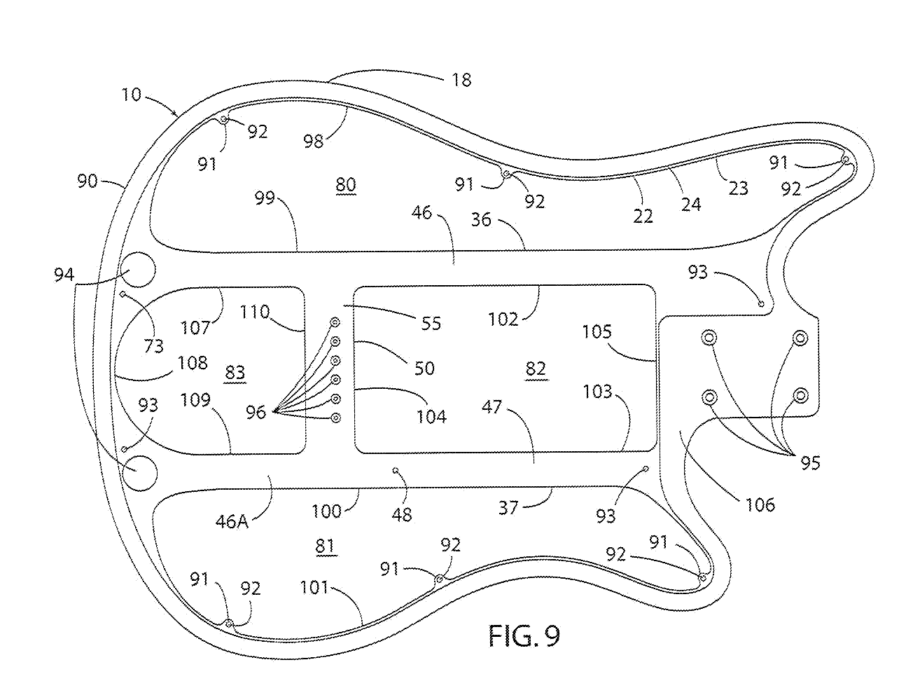

With further reference to FIG. 5, a vertically extending internal side wall 50 extends between the internal side walls 36 and 37, and is integrally formed therewith. Upper end 51 of internal side wall 50 abuts inner surface 31 of front plate member 12, and one or more threaded fasteners (not shown) extend through clearance openings 17 in front plate member 12 (see also FIG. 12), and threadably engage threaded opening 96 in side wall 50 (see also FIG. 9). The clearance openings 17 and threaded openings 96 provide for mounting of first connectors 4 (FIG. 1) to support the guitar strings 6. Extensions 52 and 53 at end 54 of internal side wall 50 form an upside-down T-shaped cross section, and end surface 55 abuts and supports rear plate member 14. One or more threaded fasteners 47 may be utilized to secure the rear plate member 14 to the primary structure 10 in the area of internal side wall 50. The cross-sectional shape of internal side wall 50 is substantially similar to internal side walls 36 and 37, except that internal side wall 50 has a thicker cross section to provide for mounting of connectors 4 via conventional threaded fasteners or the like (not shown).

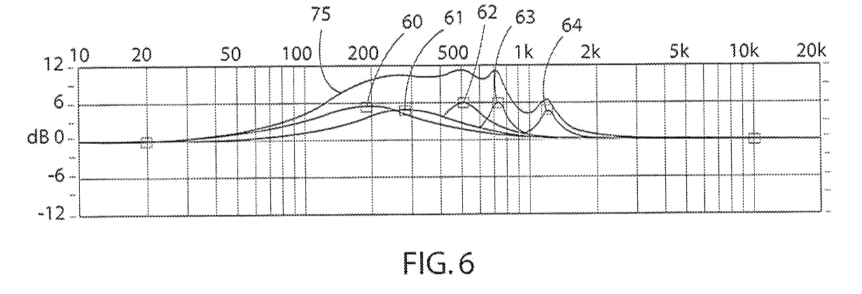

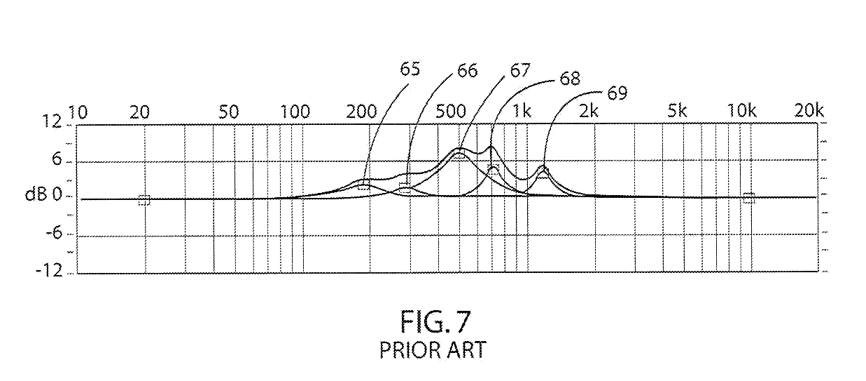

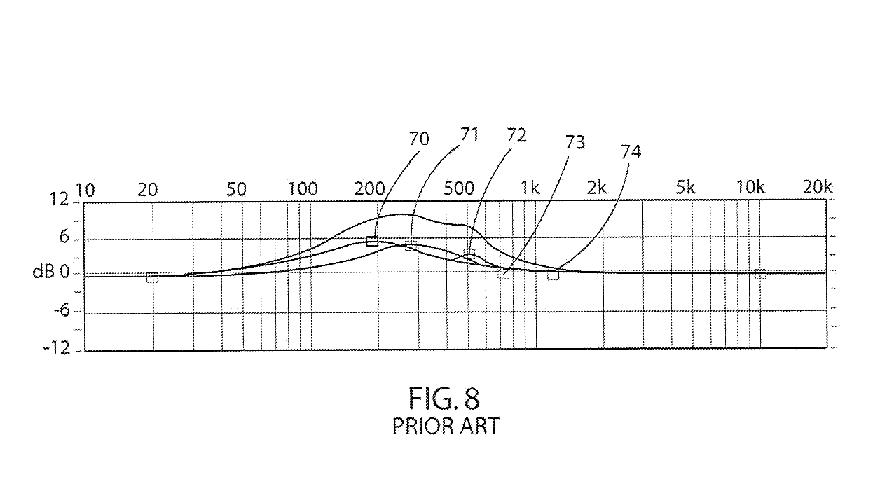

FIG. 6 is a graph showing resonant frequencies 60-64 of electric guitar 1. The shape and size of the guitar is selected to provide a desired sound as shown by the chart of FIG. 6. The resonant frequencies 60-64 may be chosen to match or emulate the resonant frequencies and sound created by prior classic guitars known for having superior sound qualities. For example, with further reference to FIG. 7, a Fender 1960 Stratocaster electric guitar includes resonant frequency peaks 65-69, and a Gibson 1959 Les Paul Reissue electric guitar (FIG. 8) includes resonant frequency peaks at the frequencies designated 70-74. It will be understood that the decibel levels shown in FIGS. 6-8 have been multiplied by an amplification factor to illustrate the shape of the curves, and the total decibel levels shown are not therefore numerically accurate. In this way, electric guitar 1 can be constructed to provide a very pleasing sound that may be chosen to emulate classic guitar sounds. Alternately, virtually any other desired sound characteristics can be chosen, and the guitar 1 can be designed to provide the sound/resonant frequencies. Because the materials utilized to make electric guitar 1 have very consistent material properties, the resonant frequency peaks 60-64 (FIG. 6) of electric guitar 1 can be precisely controlled to provide the desired tone quality and other sound characteristics. Furthermore, each guitar 1 produced according to the present invention will have substantially the same frequency peaks because the materials utilized to make each of the electric guitars 1 can be precisely controlled. Because of this, each electric guitar 1 produced has substantially identical sound. In contrast, prior electric guitars included substantial amounts of wood in the construction, and the individual guitars therefore tend to vary somewhat in sound due to the different resonant frequency peaks in each individual guitar resulting from the variations in the wood material utilized to make the guitars.

Referring again to FIG. 6, in addition to the individual resonant frequency peaks 60-64, the graph of FIG. 6 shows the total sound level 75 that results from the summation of each of the individual tone curves associated with the resonant frequency peaks 60-64. In the illustrated example, resonant frequency peak 60 occurs at 190.50 Hz, resonant frequency peak 61 occurs at 285.42 Hz, resonant frequency peak 62 occurs at 508.57 Hz, resonant frequency peak 63 occurs at 719.23 Hz, and resonant frequency peak 64 occurs at 1209.60 Hz. Although these are the preferred peak frequencies, it will be understood that a range of frequencies 60-64 may occur within a range of frequencies that still produces a pleasing sound. For example, resonant frequency peak 60 may fall within the range of about 187 Hz to about 195 Hz, resonant frequency peak 61 may fall in the range of about 279 Hz to about 292 Hz, resonant frequency peak 62 may occur in the range of about 494 Hz to about 521 Hz, the resonant frequency peak 63 may occur in the range of about 700 Hz to about 738 Hz, and the resonant frequency peak 64 may occur in the range of about 1177 Hz to 1243 Hz.

Each of the resonant frequency peaks 60-64 is preferably controlled such that they fall between the frequencies of standard musical notes as defined by, for example, the American Standard Pitch scale. In the illustrated example, the resonant frequency peak 60 of 190.50 Hz is selected to fall between the standard musical notes F^{#}₃/G^{b}₃ (185.00 Hz) and the note G3 (196.00 Hz). Because the resonant frequency peak 60 is positioned between the standard musical notes, the electric guitar 1 will not resonant excessively when a player plays the instrument at the adjacent musical notes having frequencies of 185 Hz and 196 Hz. It will be appreciated that known prior stringed instruments such as electric guitars often have a resonant frequency peak at or directly adjacent to a standard musical note. If a player hit a musical note at or directly adjacent to a resonant frequency peak, the guitar tends to produce a louder sound that may be unpleasant, and detract from the overall sound quality of the guitar.

The other resonant frequency peaks 61-64 are also selected/controlled such that they fall between adjacent standard musical notes. In the illustrated example, the resonant frequency peak 61 (285.42 Hz) falls between the musical notes C^{#}₄/D^{b}₄ (277.18 Hz) and the note D₄ (293.66 Hz), the resonant frequency peak 62 falls between B₄ (493.88 Hz) and C₅ (523.25 Hz), the resonant frequency peak 63 falls between the notes F₅ (698.46 Hz) and F^{#}₅/G^{b}₅ (739.99 Hz) and the resonant frequency peak 64 falls between the notes D₆ (1174.66 Hz) and D^{#}₆/E^{b}₆ (1244.51 Hz).

It will be understood that, in general, the electric guitar 1 will have a very large number of resonant frequencies. However, the resonant frequencies having the lowest frequencies contribute more to the overall sound of the electric guitar 1, such that control of the lower resonant frequencies is most important in controlling the overall sound of the electric guitar 1. Also, although the resonant frequency peaks 60-64 preferably fall directly between adjacent standard musical notes in terms of frequencies, it will be understood that the resonant frequency peaks of electric guitar 1 may not be precisely centered between adjacent standard musical notes. In general, the resonant frequency peaks 60-64 (and higher resonant frequency peaks) are at least one quarter of a half step away from the adjacent standard musical notes to avoid exciting the resonant frequencies of the electric guitar 1. However, if the resonant frequency of the electric guitar 1 is within a third of a half step of an adjacent standard musical note, the sound will, in general, still be acceptable. In general, if a resonant frequency peak 60-64 (or higher frequency peak) is less than one quarter of a half step off or more relative to a standard musical note, the electric guitar 1 will tend to produce feedback and other problems that detract from the sound of the electric guitar 1.

With reference back to FIG. 1, the space between front plate-like member 11 and rear plate-like member 14 bounded by side wall 18 and internal side wall 36 defines a first (upper) tone chamber 80. Similarly, the space between front plate-like member 13, rear plate-like member 14, and side walls 18 and 37 defines a second (lower) tone chamber 81. The space between front plate member 13, rear plate member 14, and internal side walls 36, 37, 50, and outer side wall 18 defines a third (center front) tone chamber 82. Finally, the space between front plate member 12, rear plate member 14, internal side walls 36, 37, 50 and outer side wall 18 defines a fourth (center rear) tone chamber 83. The tone chambers 80-83 are further illustrated in FIG. 9.

It will be understood that the volume of the tone chambers 80-83 has a substantial affect on the resonant frequency peaks 60-63. An example of a prior art work describing the acoustics of stringed instruments is “Acoustics for Violin and Guitar Makers”, Fourth Edition 2002, Chapter II: Resonance and Resonators, Erik Jansson (http://www.speech.kth.se/music/acviguit4/part2.pdf), the entire contents of which are incorporated by reference. (The resonant frequency peak 64 is a higher-order resonant frequency peak that is not a direct result of a single one of the tone chambers 80-83). In the illustrated example, the first tone chamber 80 has a volume of 53.17 cubic inches. This volume produces a resonant frequency peak of about 190.50 Hz. The second tone chamber 81 has a volume of about 43.69 cubic inches, and this tone chamber produces the resonant frequency peak 61 of 285.42 Hz. The third tone chamber 82 has a volume of 31.06 cubic inches, and this tone chamber produces the resonant frequency peak 62 of 508.57 Hz. Finally, the fourth tone chamber 83 has a volume of about 15.23 cubic inches, and the fourth tone chamber 83 produces the resonant frequency peak 63 of 719.23 Hz.

By precisely controlling the volume of the tone chambers 80-83, the body portion 2 of the electric guitar 1 can be precisely designed and fabricated to provide the desired resonant frequency peaks 60-64 described above. Because the material used to form the primary structure 10 is a stable aluminum material (preferably 6061) and also because the plate members 11-13 and 14 are made of a stable carbon fiber composite material, the volumes of the tone chambers 80-84 can be very precisely controlled to provide the desired resonant frequencies 60-64, and to reduce or eliminate variations from one instrument to the next.

With reference to FIG. 9, primary structural member 10 includes a peripheral outer surface 90 formed by side wall 18. As discussed above, side wall 18 includes a notch 22 formed by flat surfaces 23 and 24 to support the front plate-like members 11-13. A plurality of tabs 91 include threaded openings 92 that receive threaded fasteners to secure the rear plate member 16 to the primary structural member 10. A plurality of additional threaded openings 93 also provide for mounting of rear plate member 14. Primary structure 10 may include a pair of cavities 94 to lighten the primary structure 10. The cavities 94 are preferably blind holes that are bored to within no less than about 0.050 inches of the rear face 17 of primary structural member 10. Cavities 94 are formed to reduce the weight of primary structure 10, but they do not have a significant impact on the sound of guitar 1, and the dimensions between the base surface of cavities 94 and rear face 17 are not critical, provided sufficient material remains to provide the desired strength. Primary structural member 10 also includes a plurality of threaded openings 95 that provide for rigidly securing the neck 3 to the primary structure 10. Threaded openings 96 receive conventional threaded fasteners (not shown) for mounting the first connectors 4 to support the guitar strings 6. The primary structural member 10 is preferably made of a 6061 aluminum material that has been anodized to prevent corrosion and other degradation.

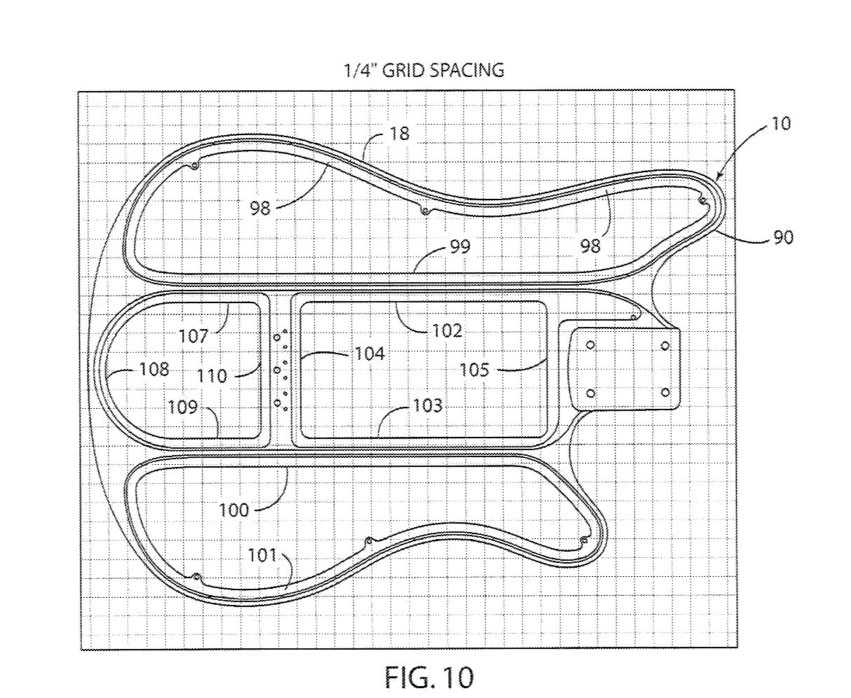

Although the primary structure 10 may have a variety of configurations, in the illustrated example the primary structure 10 has a contour as illustrated in FIGS. 9 and 10. FIG. 10 shows the primary structure 10 with a grid having 0.250 spacing laid superimposed on the primary structure 10 to show the dimensions and shape of the outer periphery 10, and inner surface 98 of side wall 18. The inner surface 98 of side wall 18 and upper surface 99 of internal wall 36 face the first tone chamber 80. Similarly, the lower surface 100 of internal side wall 37 and inner surface 101 of side wall 18 face the second tone chamber 81. A lower surface 102 of internal side wall 36, an upper surface 103 of side wall 37, a side surface 104 of internal wall 50, and a side surface 105 of a front portion 106 of side wall 18 face the third tone chamber 82. A lower surface 107 of internal side wall 36, an inner surface 108 of side wall 18, an upper surface 109 of side wall 37, and a side surface 110 of internal side wall 50 face fourth tone chamber 83.

As discussed above, the volume of the tone chambers 80-83 is a primary factor determining the resonant frequency peaks 60-63. However, the sound produced by the electric guitar 1 is also affected somewhat by the shape of the tone chambers 80-83. In particular, the tone chambers 80-83 are configured to reduce the number of opposite parallel wall surfaces that could otherwise produce standing waves within the tone chambers 80-83. For example, although the surface 99 of first tone chamber 80 substantially flat, the surface 98 opposite surface 99 is gently curved to thereby avoid producing standing waves between the surfaces 98 and 99. Similarly, the surface 101 of tone chamber 81 is curved to prevent formation of standing waves between surfaces 100 and 101. As described in more detail, although the plate-like members 11-14 have substantially flat inner surfaces facing the tone chambers 80-83, the inner surfaces of the plate members 11-14 have a rough surface formed by carbon fibers. The rough inner surface of plate members 11-14 breaks up the sound waves, and substantially prevents formation of standing waves that otherwise might form in a front-to-rear direction, reflecting off the inner surfaces of the plate members 11-14.

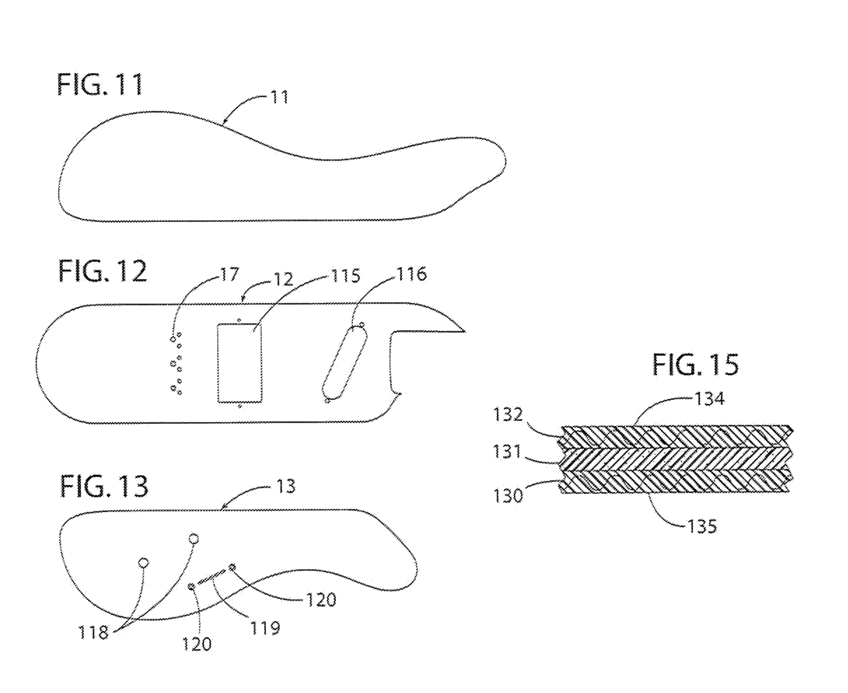

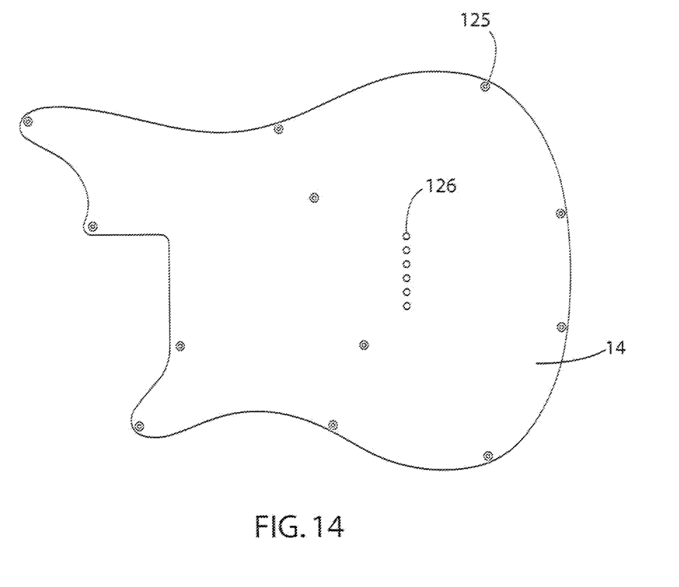

Front plates 11, 12 and 13 have the profiles/shapes shown in FIGS. 11-13. As shown in FIG. 12, plate 12 includes openings 115 and 116 that are shaped to receive electric pick ups 7. Openings 117 provide clearance for conventional threaded fasteners or the like (not shown) to mount the first guitar string connectors 4. Plate 13 includes clearance openings 118, 119, and 120 that provide clearance for controls 8.

The rear plate 14 (FIG. 16) has a contour as shown in FIG. 16, and includes a plurality of clearance openings 125 that receive threaded fasteners that engage threaded openings 92 (FIG. 9) in primary aluminum structure 10. A plurality of optional openings 126 may be utilized to provide for mounting of guitar strings 6 through the rear of guitar 1 in a conventional manner. It will be understood that other suitable guitar string mounting arrangements are also known, such that clearance openings 125 would not be needed in such case.

With reference to FIG. 17, each of the carbon fiber plate members 11-14 include an outer layer 130 that comprises two layers of woven carbon fiber cloth oriented at forty-five degrees relative to one another. Layer 130 includes a polymer resin matrix. A middle layer 131 is disposed on the outer layer 130. The layer 131 comprises a polymer resin matrix with wood powder or particles imbedded in the matrix. A third, or inner layer 132 includes a single layer of carbon fiber cloth and a polymer resin matrix.

The combination of layers 130, 131 and 132 provides a plate construction for the plates 11-14 that is sufficiently flexible to provide the desired tone and vibration characteristics. The wood particles disposed in second layer 131 provide for a dampen-type affect that improves the sound and tone qualities of the electric guitar 1. In a preferred embodiment, the wood particles comprise crushed birch wood particles that are somewhat larger than a typical sawdust particle.

During fabrication of the plates 11-14, two layers of carbon fiber cloth are first laid on a flat, machined surface (not shown) or the like at forty-five degree angles relative to one another, and liquid polymer resin is brushed, or otherwise applied to the layers of cloth. The wood particles of layer 131 are then spread onto the layer 130, and additional gel coat is added to surround the wood particles. The layers 130 and 131 may then be compressed to squeeze out excess polymer resin material, and the single carbon fiber cloth of layer 132 is then laid on top of the layer 131, and additional liquid resin matrix material is then applied to the carbon fiber cloth of layer 132. The outer surface 135 of outer layer 130 is very smooth due to its being formed on a flat, smooth surface, and therefore provides a smooth outer surface that contributes to the unique, aesthetically pleasing appearance of guitar 1. The carbon fibers of the cloth embedded in outer layer 130 are visible through the translucent or clear resin matrix of outer layer 130, further contributing to the unique appearance of guitar 1. In contrast to smooth outer surface 135, inner surface 134 of inner layer 132 is quite rough due to the carbon fibers of layer 132 being at, or directly adjacent to, inner surface 134. The rough surface 134 forms an inner surface of the plate members 11-14 facing tone chambers 80-83. The rough surface 134 alleviates formation of standing sound waves within tone chambers 80-83 that could otherwise occur between the parallel inner surfaces of the front plate members 11-13, and the inner surface of rear plate member 14.

The electric guitar 1 of the present invention can be designed to provide a specific sound quality. As discussed above, the desired resonant tone curve (FIG. 6) can be determined before the guitar 1 is fabricated, and the sizes and shapes of the tone chambers 80-83 can be selected to provide the desired resonant tone curve. In this way, a stringed instrument such as electric guitar 1 can be fabricated to provide a very precise sound and tone. Also, as discussed above, the peaks of the resonant tone curves can be selected to fall between the frequencies of standard musical notes to thereby avoid the problems associated with known prior instruments wherein a resonant frequency of an instrument falls on, or is close to, a standard musical note. Still further, each guitar 1 or other stringed instrument produced according to the present invention will have virtually the same sound qualities because the dimensions and physical properties of the carbon fiber and aluminum components to make the guitar 1 are consistent between each instrument produced.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An electric guitar, comprising:
a body including a plurality of first connectors adapted to hold guitar strings;
an elongated neck extending from the body, the neck including a plurality of second connectors adapted to hold guitar strings in tension;
at least one pickup adapted to generate a signal that can be communicated to an amplifier; and wherein:
at least a first portion of the body is made of a metal material, and a second portion of the body is made of a carbon fiber composite material, the first and second portions of the body defining at least one internal cavity, the body defining a plurality of resonant frequencies in the range of about 100 Hz to about 2000 Hz, wherein each of the resonant frequencies are at least one half step of a half step away from each of the frequencies of musical notes as defined by the American Standard Pitch scale.

2. The electric guitar of claim 1, wherein:
the body defines front and rear faces, and edge portions extending between the front and rear faces;
at least a portion of the edge portions is formed by the first portion of the body, and the front and rear faces are formed by the second portion of the body.

3. The electric guitar of claim 2, wherein:
the first portion of the body comprises side wall portions having outer surfaces forming the edge portions, and an inner surface portion facing the cavity.

4. The electric guitar of claim 3, wherein:
the side wall portions of the first portion of the body define opposed front and rear edge portions;
the second portion of the body comprises a front piece and a rear piece, the front and rear pieces defining peripheral edges and wherein at least a portion of each peripheral edge is connected to a selected one of the front and rear edge portions of the side wall portions.

5. The electric guitar of claim 4, wherein:
the front and rear edge portions define an outer edge surface extending transversely inwardly from the outer surface, an inwardly-facing first lip surface extending transversely relative to the outer edge surface, and an outwardly-facing second lip surface that is generally parallel to the front and rear faces, and wherein:
the front and rear faces abut the second lip surfaces.

6. The electric guitar of claim 1, wherein:
the body includes a plurality of tone chambers, each tone chamber generating a resonant tone having a peak frequency.

7. The electric guitar of claim 6, wherein:
at least a first one of the tone chambers has a volume in the range of about 51.2 cubic inches to about 55.2 cubic inches.

8. The electric guitar of claim 7, wherein:
the first tone chamber has a volume in the range of about 53.2 cubic inches.

9. The electric guitar of claim 7, wherein:
at least a second one of the tone chambers has a volume in the range of about 41.7 cubic inches to about 45.7 cubic inches.

10. The electric guitar of claim 9, wherein:
the second one of the tone chambers has a volume of about 43.7 cubic inches.

11. The electric guitar of claim 9, wherein:
at least a third one of the tone chambers has a volume in the range of about 29 cubic inches to about 33 cubic inches.

12. The electric guitar of claim 11, wherein:
the third tone chamber has a volume of about 31.1 cubic inches.

13. The electric guitar of claim 11, wherein:
at least a fourth one of the tone chambers has a volume in the range of about 13.2 cubic inches to about 17.2 cubic inches.

14. The electric guitar of claim 13, wherein:
the fourth tone chamber has a volume of about 15.2 cubic inches.

15. The electric guitar of claim 6, wherein:
the body includes a primary structure made of a first material having at least one opening therethrough, and front and rear plate-like members made of a second material that is different than the first material, the front and rear plate-like members closing off the one opening to form the one internal cavity.

16. The electric guitar of claim 15, wherein:
the first material is non-wood, and the second material comprises a composite including fibers and a matrix material.

17. The electric guitar of claim 16, wherein:
the primary structure defines front and rear faces that are substantially parallel to one another, and the front and rear plate-like members are secured to the front and rear faces, respectively.

18. The electric guitar of claim 15, wherein:
the front and rear plate-like members have inner surfaces facing the cavity, the inner surfaces having a sufficiently rough texture to substantially prevent formation of standing waves traveling between the inner surfaces.

19. The electric guitar of claim 18, wherein:
the plate-like members include a layer of fiber material, and the rough surface texture is formed, at least in part, by fibers of the fiber material.

20. The electric guitar of claim 19, wherein:
the layer of fiber material comprises woven carbon fiber cloth.

21. The electric guitar of claim 19, wherein:
the plate-like members include a resin matrix material having wood particles embedded therein.

22. The electric guitar of claim 15, wherein:
the plate-like members have substantially flat inner and outer surfaces that are parallel to one another.

23. The electric guitar of claim 1, wherein:
the electric guitar has resonant frequency peaks in the ranges of about 187 Hz to about 194 Hz and about 279 Hz to about 292 Hz.

24. The electric guitar of claim 23, wherein:
the electric guitar has a resonant frequency peaks in the ranges of about 494 Hz to about 521 Hz and about 700 Hz to about 738 Hz.

25. A method of making a stringed musical instrument having a body, a neck, and a plurality of strings, the method comprising:
determining desired resonant tone characteristics for the musical instrument;
determining a shape of the body of the musical instrument that will provide at least some of the desired tone characteristics for the musical instrument;
fabricating the body of the musical instrument from materials having sufficiently consistent material properties so as to consistently provide the desired tone characteristics, and wherein at least substantial portion of the body of the musical instrument is made of a material other than solid wood.

26. The method of claim 25, wherein:
the step of determining the desired tone characteristics includes determining the frequency of at least one desired resonant frequency peak.

27. The method of claim 26, wherein:
the step of determining the shape of the body includes determining a volume of a tone chamber in the body that will produce the desired resonant frequency peak.

28. The method of claim 27, wherein:
a plurality of desired resonant frequency peaks are determined; and
the volume of a plurality of tone chambers providing the desired resonant frequency peaks is determined.

29. The method of claim 25, wherein:
the step of fabricating the body includes forming a primary structure having front and rear faces and at least one opening through the primary structure from the front face to the rear face.

30. The method of claim 29, including:
fabricating front and rear plate members;
securing the front and rear plate members to the primary structure with the front and rear plate members closing off the opening through the primary structure to form a tone chamber having a resonant frequency that contributes to the desired tone characteristics.

31. The method of claim 25, including:
forming a first portion of the body of the musical instrument from metal;
forming a second portion of the body of the musical instrument from a fiber composite material;
connecting the first and second portions of the body together to form a tone chamber having a resonant frequency that contributes to the desired tone characteristics of the musical instrument.

32. The method of claim 25, including:
securing electrical pick ups to the body of the musical instrument whereby the musical instrument comprises an electric guitar.
